(19) United States
(12) Patent Application Publication
(10) Pub. No.: US 2009/0195790 A1
(43) Pub. Date: Aug. 6, 2009

(54) IMAGING SYSTEM AND METHOD

(75) Inventors: Xiang Zhu, Ottawa (CA); I. Christine Smith, Ottawa (CA); Chad English, Ottawa (CA)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: NEPTEC, Ontario (CA)

(21) Appl. No.: 12/065,448

(22) PCT Filed: Aug. 9, 2006
(86) PCT No.: PCT/CA06/01313

§ 371 Date: Aug. 29, 2008

(30) Foreign Application Priority Data
Sep. 2, 2005 (US) 60/713337

(51) Int. Cl. G01B 11/24

(52) U.S. Cl. 356/612

(57) ABSTRACT

An apparatus for measuring the coordinates of a point on the surface of an object comprises a projection system for projecting a beam of energy onto the surface of the object, a receiving system for receiving reflected beam energy from the target surface, and a detector for detecting the received energy. The projection system comprises a beam expander for expanding the width of the beam, and a focussing device for focussing the projected beam. The position of the reflected beam energy at the detector provides a measure of the range of the point on the target surface using triangulation and the direction of the projected beam provides the x and y coordinates. The focussing device can be controlled to vary the focal length of the projected beam and to control the beam size at the target object to vary the area of the target surface illuminated by the beam and thereby to control the resolution of the measurements.

### FIELD OF THE INVENTION

The present invention relates to imaging systems and methods, and in particular, but not limited to, imaging systems capable of acquiring surface profile information.

### BACKGROUND OF THE INVENTION

There are a number of existing systems which are used to measure the surface profile of an object in 3-dimensions. These 3-dimensional coordinate measurement machines (CCM) include vision scanning probes and contact probes. Some vision scanning probes use a system of rotating mirrors to perform a 2-dimensional raster scan across an object and use a triangulation method to measure the range. Other vision scanning probes use a pulsed laser and Time of Flight (TOF) technique to measure range information. High precision galvanometers may be used to drive the scanning mirrors and these enable high speed 2-dimensional scans to be performed. These instruments typically use a collimated laser beam having a diameter of approximately 1 mm (i.e. a diameter approaching the lower limit of present optical systems) in order to maintain a uniform measurement resolution throughout a relatively large volume of, for example 1 m³. Examples of vision scanning probes include triangulation-based 3-D laser cameras, which have found wide application from human contour digitization to object tracking and imaging for space applications.

In an active triangulation system, a beam of radiation such as laser light is projected onto an object and a position sensitive detector detects the position of the beam reflected from the object. Distance information, i.e. the position of the surface region of the object struck by the beam in the z-direction, otherwise known as the range, is derived mathematically from the projection direction as given by the angular position of the beam scanning mechanism and the position of the reflected beam as measured by the position sensitive detector. FIG. 1 shows a schematic diagram of a one-dimensional triangulation system, i.e. a system which measures range information only. The system 1 comprises a laser source 3, a collection lens 5 and a detector array 7. A laser beam 9 is projected onto a target object 11 and the reflected beam 13 is imaged by the lens 5 onto the detector array 7. When the target moves in the range direction (for example as indicated by the arrow “R”), the corresponding spot image moves along the array.

By trigonometry, the (x, z) coordinates of the illuminated point on the object are given by

$$z = \frac{{kf}_{0}}{p + {f}_{0} tan α}$$

and x=ztanα, where p is the position of the imaged spot on the detector, α is the deflection angle of the laser beam, k is the separation between the lens and the laser source, and f₀ is the effective distance between the position detector and lens.

Similarly, in a 2 or 3-D imaging system, changes in the range direction of the surface as the surface is scanned laterally also results in movement of the spot image along the array. Thus, by reading the position of the spot on the detector array, the range profile of an object can be determined.

To obtain range information as a function of lateral position, the projecting laser beam may be scanned in the x and y directions and the range measured at different positions in the scan. The detector array may be moved with the scanning projected beam, so that changes in the position of the beam at the detector array are only attributable to changes in the range.

Examples of a 3-dimensional imaging system are described in U.S. Pat. No. 4,627,734, by Rioux (the entire content of which is incorporated herein by reference), and a physical implementation of a 3-dimensional imaging system which is based on one of these examples is shown in FIG. 2. Referring to FIG. 2, the imaging system 100 comprises a laser input 103, a collimator 105 for collimating the laser beam, x and y scanning mirrors 107, 109 for scanning the projected beam in the x and y directions, respectively, first and second, fixed side mirrors 111, 113, y and x scanning receiving mirrors 115, 117, a collection lens 119 and a position detector 121. In operation, the collimated laser beam 123 from the collimator is directed onto the x-scanning mirror 107 via a fixed mirror 125 and a through hole 127 formed in the y-scanning mirror 109. The x-scanning mirror 107 reflects the beam onto the first fixed side mirror 111. The side mirror 111 reflects the beam onto the y-scanning mirror 109 which subsequently projects the beam onto a surface 129 to be imaged. The beam 131 reflected from the surface 129 is first received by the receiving y-scanning mirror 115, then reflected onto the second fixed side mirror 113 and onto the receiving x-scanning mirror 117. The receiving x-scanning mirror 117 reflects the collected beam onto the detector 121 via the collection lens 119. The x and y coordinates of the beam position at the surface are determined from the angular position of the x- and y-scanning mirrors, and the z-coordinate (or range) of the surface is determined from the position of the collected beam on the position sensitive detector 121. In this arrangement, the projected and reflected beams are scanned simultaneously, without the need to physically move either the source or detector. Furthermore, the beams are scanned in such a way that scanning a planar surface positioned orthogonal to the range direction results in nil change (to a first order approximation) in the position of the beam at the detector, (in practice there is some small dependence of the position at the detector on the angular position of the x and y mirrors). Thus, the position of the beam on the detector provides range information.

Most 3-D active triangulation systems project collimated circular beams or collimated line beams on the target object, and in most applications, a beam size of 1 mm is used to minimize the beam divergence over the entire range distance. With a beam size of 1 mm, the lateral resolution (x, y-direction) is normally on the order of a millimeter.

Contact probe type coordinate measurement machines are capable of providing higher resolution measurements in the range direction than presently available vision scanning probes. An example of a contact probe instrument uses a collimated, 1 mm diameter laser beam and an interferometer mounted on a pan-tilt unit to scan the beam in two dimensions. To achieve high resolution measurements in the range direction, the area of the object illuminated by the 1 mm laser beam must be planar. To achieve high resolution measurements in three dimensions, a secondary device is required. In one example, the secondary device comprises a mirrored spherical probe having a spherical portion and two radially positioned, mutually orthogonal planar mirrors for receiving and returning the laser beam from and to the interferometer. The spherical portion of the probe is manually mounted on the object to be scanned, allowing the scanner to measure the 3-D coordinates of the point touched by the spherical probe. Although such instruments are capable of achieving higher resolutions than vision scanning probes, both the pan-tilt system and the requirement for repeated manual repositioning of the spherical probe result in slow speed measurements.

There is therefore a need for a metrology system which is capable of making higher resolution measurements of objects in three dimensions at reasonable or even high speed scanning rates.

### SUMMARY OF THE INVENTION

According to one aspect of the present invention, there is provided an apparatus comprising a projection system for projecting a beam of energy onto a target surface, a receiving system for receiving reflected beam energy from the target surface, a detector for detecting the received energy; wherein the projection system comprises a beam expander for receiving a beam of energy and expanding the width of the beam, and a focusing device for focusing the projected beam.

In this arrangement, the projection system includes a beam expander for expanding the width of a beam of energy to be projected onto a target object and a focusing device for focusing the projected beam. Advantageously, this combination provides the ability to significantly reduce the size of the beam at the target surface, thereby reducing speckle noise, edge effects and increasing the lateral and range resolutions of the instrument.

In one embodiment, the beam expander is capable of expanding the beam to a beam size of 5 mm or more, for example, 10 mm or more, 15 mm or more, 20 mm or more or 25 mm or more. Generally, the larger the beam exiting the focusing device, the smaller the beam width at the focal point, and the higher the resolution of the instrument.

In some embodiments, the focusing device is capable of focusing the beam to a width of 500 microns or less, for example 400 microns or less, 300 microns or less, 200 microns or less, 100 microns or less or 75 microns or less.

In some embodiments, the apparatus includes a device for receiving the reflected beam energy and passing the beam energy to the detector. The device may comprise an imaging device having an optical aperture for directing the beam energy onto the detector at a position which depends on the angle between the incident and reflected beam energy at the target surface. The device may for example comprise a focussing device, such as one or more lenses. This enables the range of the target surface to be measured using triangulation.

In some embodiments, the apparatus may be used to make a single point measurement. In other embodiments, the apparatus may be adapted for making one or 2-dimensional measurements, and for this purpose, the apparatus may be adapted so that the beam can be scanned over the surface of the object by moving the apparatus relative to the surface, the target object relative to the apparatus or a combination of both.

In some embodiments, the projection system further comprises a beam steering system for steering the projected beam and thereby varying the beam trajectory. This arrangement removes the need for moving either the projection system or the target object when making measurements at different positions on the target surface. Alternatively, or in addition, the beam receiving system may comprise a beam steering system to steer the beam reflected from the target surface onto the detector. This obviates the need to move the detector or the object when making measurements at different positions on the target surface. The steering system for the reflected beam may be operated synchronously with a projection beam steering system so that multi-point measurements can be made over the target surface without moving the apparatus or the surface.

In some embodiments, the beam steering system comprises a first device for steering the beam along a first direction and a second device for steering the beam along a second direction, orthogonal to the first direction. This arrangement allows the beam to be steered in two dimensions, for example, in both lateral x and y directions.

In some embodiments, the second device includes a planar reflector member and the beam is introduced into the beam steering system between the first and second devices and in a direction generally along the plane of the planar reflector member. Advantageously, this arrangement obviates the need to introduce the beam through a hole in one of the beam steering devices, for example, the y-mirror in FIG. 2. As can be seen from FIG. 2, the through hole 127 which is formed to accept a beam width of 1 mm would need to be considerably enlarged to accept a much larger beam having a beam width of, for example, 10 mm or more. Furthermore, as the plane of the y-mirror 109 is rotated towards alignment with the plane of the figure, the effective aperture size “seen” by the beam decreases. Therefore, to accept a larger beam at these small angles, the through hole 127 would need to be enlarged across the width “W” of the mirror so that the through hole has the form of an ellipse with the major axis directed across the width of the mirror. Such enlargement of the through hole 127 would necessitate increasing the size of the mirror to provide sufficient supporting structure. In turn, this could have the disadvantage of reducing the available field of view. The y-mirror shown in FIG. 2 is made as light as possible to minimize its inertia so that its position can be rapidly changed by the drive motor (e.g. galvanometer) 133. In order to minimize its inertia, its length is made as short as possible by positioning the y-mirror as close as possible to the fixed mirrors 111, 113. In addition, to reduce its inertia, the projection side 109 of the y-mirror has a reduced width in comparison to the receiving side 115 and the mirror is formed of a lightweight material such as beryllium. Therefore, increasing the size of the aperture 127 would necessarily require the mirror to be enlarged to provide the requisite support structure which would in turn increase its inertia and reduce the available scanning rate.

In some embodiments, the projection system further comprises a reflector for reflecting the beam onto the first scanning device. In one embodiment, the reflector comprises a prism. The prism is arranged to pass the beam through a front facet thereof, reflect the beam from its rear facet and transmit the reflected beam through its side facet. Not only can a prism accept a relatively large beam, but since the effective support structure is in front of the reflective surface (unlike a mirror whose support structure is behind the reflective surface), it can provide a compact reflector without compromising the field of view.

In some embodiments, the first steering device comprises a member having first and second opposed surfaces, the first surface being reflective and having a width, and wherein the width of the reflective surface is greater than or equal to the distance between the first and second surfaces. In this arrangement, the first device can have the form of a plate in which the reflective surface on the planar surface of the plate has a width which is greater than the thickness of the plate so that the device can both accept a relatively large beam width and at the same time can be made lightweight and compact. Advantageously, this allows the device to be driven rapidly from one position to another.

In some embodiments, the focusing device comprises a variable focusing device for varying the focal length of the projected beam. Advantageously, the provision of a variable focusing device allows the size of the beam at the target surface to be controlled. For example, this arrangement allows the focal position of the beam to be made coincident with the target surface, or the beam size at the target surface to be otherwise controlled, as the effective beam length to the target surface varies on changing the lateral position of the beam (e.g. during scanning). This arrangement also allows the focal position of the beam to be made coincident with the target surface as the position of the target surface struck by the beam changes in the range (i.e. z) direction.

In some embodiments, the apparatus further comprises a measuring system for measuring a parameter indicative of whether the beam is focused at the target object. For example, in one embodiment, the detector comprises a position detector for detecting the position of the received beam energy. The position of the surface in the range direction can be determined from the detected position. This information can then be used to determine the distance between the apparatus and the object and the focal length of the beam can be adjusted accordingly. For example, the 3-dimensional co-ordinates of the surface region on which the beam is incident can be determined from the projected beam trajectory (as, for example, determined by the position of the scanning or steering system) and the range position can be determined from the position detector. Using this information, the distance between the focusing device and the target surface can be calculated and this distance provides a measure of the focal length of the beam necessary to focus the beam at the surface.

In any embodiment, the projection system may comprise an x and/or y scanning device. A reflector device may be arranged to reflect a beam from one scanning device to the other.

In any embodiment, the receiving system may comprise an x and/or y scanning device. A reflector device may be arranged to reflect a beam from one scanning device to the other.

In any embodiment, a driver means may be arranged to drive movement of an x-scanner of the projection system and receiving system synchronously.

In any embodiment, a driver means may be arranged to drive movement of a y-scanner of the projection system and receiving system synchronously.

According to another aspect of the present invention, there is provided an apparatus comprising a projection system for projecting a beam of energy onto a target object, a receiving system for receiving reflected beam energy from the target object, a detector for detecting the received energy; wherein said projection system comprises a variable focusing device for varying the focal length of the projected beam and for focusing the beam onto the target object.

According to another aspect of the present invention, there is provided a method of obtaining information about a target object comprising the steps of: projecting a beam of energy onto a target object, measuring a parameter for use in focusing the beam onto the object, controlling the focal length of the beam based on said parameter to control the size of the beam at said object, receiving beam energy reflected from said object, detecting the position of the reflected beam energy, and based on said detected position, determining the position of the beam on said target along a z-direction extending between said object and a reference position spaced from said object.

According to another aspect of the present invention, there is provided a method of obtaining information about a target surface comprising generating from said surface first data containing information about said target surface, identifying a feature from said first data, and generating from said target surface second data containing information about said feature, wherein the second data contains different information about said feature than said first data.

### BRIEF DESCRIPTION OF THE DRAWINGS

Examples of embodiments of the present invention will now be described with reference to the drawings, in which:

FIG. 1 shows a schematic diagram of a 1-dimensional measuring system;

FIG. 2 shows a plan view of a 3-dimensional imaging device;

FIG. 3 shows a perspective view of an apparatus according to an embodiment of the present invention;

FIG. 4 shows a schematic diagram of an apparatus according to an embodiment of the present invention;

FIG. 5 shows an example of a ray diagram of the embodiment of FIG. 4;

FIG. 6 shows a simplified geometrical model of an embodiment of the apparatus;

FIG. 7 shows a schematic diagram of a measuring system illustrating the effect of speckle noise;

FIG. 8A shows a graph of relative beam intensity versus pixel number of a detector array where the array is positioned at target location;

FIG. 8B shows a graph of relative light intensity as a function of pixel number of an array at the image detector;

FIG. 8C shows an example of a graph of relative light intensity as a function of pixel number of an array at the detector for a larger spot size on the object than shown in FIG. 7B;

FIG. 9A shows a schematic diagram of a measuring system illustrating edge effects from an occlusion in a target object;

FIG. 9B shows a schematic diagram illustrating edge effects at an interface of a target object with different reflectance;

FIG. 10A shows a graph of peak position as a function of distance in an edge scan;

FIG. 10B shows an example of a graph of peak position versus distance in another edge scan;

FIG. 11 shows a graph of displacement versus peak position;

FIG. 12 shows a schematic diagram of an example of a focusing device for use in embodiments of the invention;

FIG. 13 shows an example of another focusing device for use in embodiments of the invention;

FIG. 14 shows an example of a beam conditioning system for use in embodiments of the invention;

FIG. 15 shows an example of another beam conditioning system for use in embodiments of the invention; and

FIG. 16 shows a schematic diagram of a beam expander according to an embodiment of the invention.

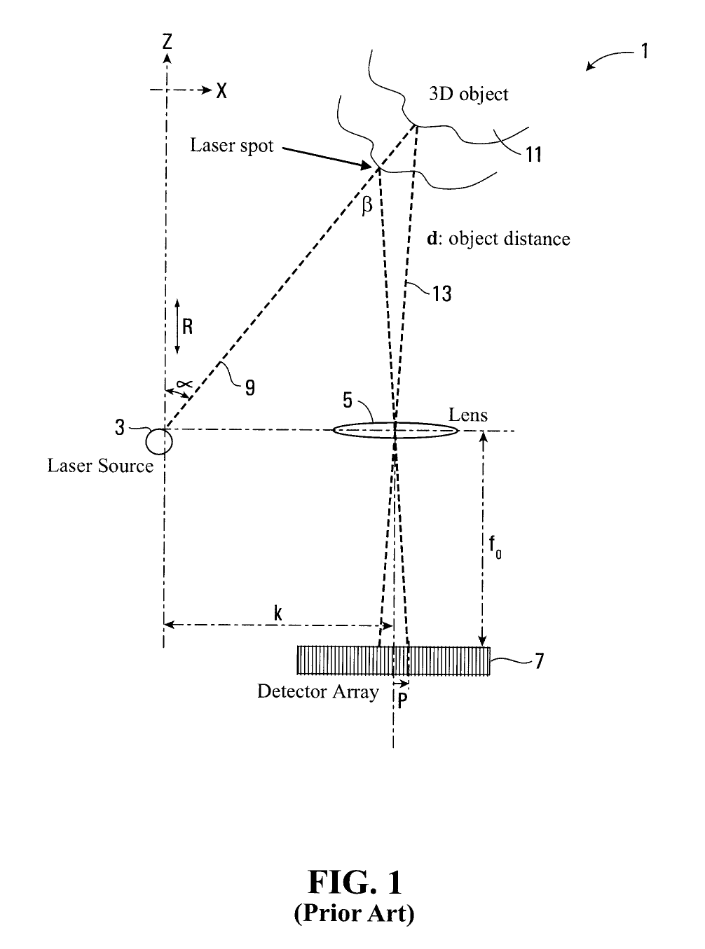

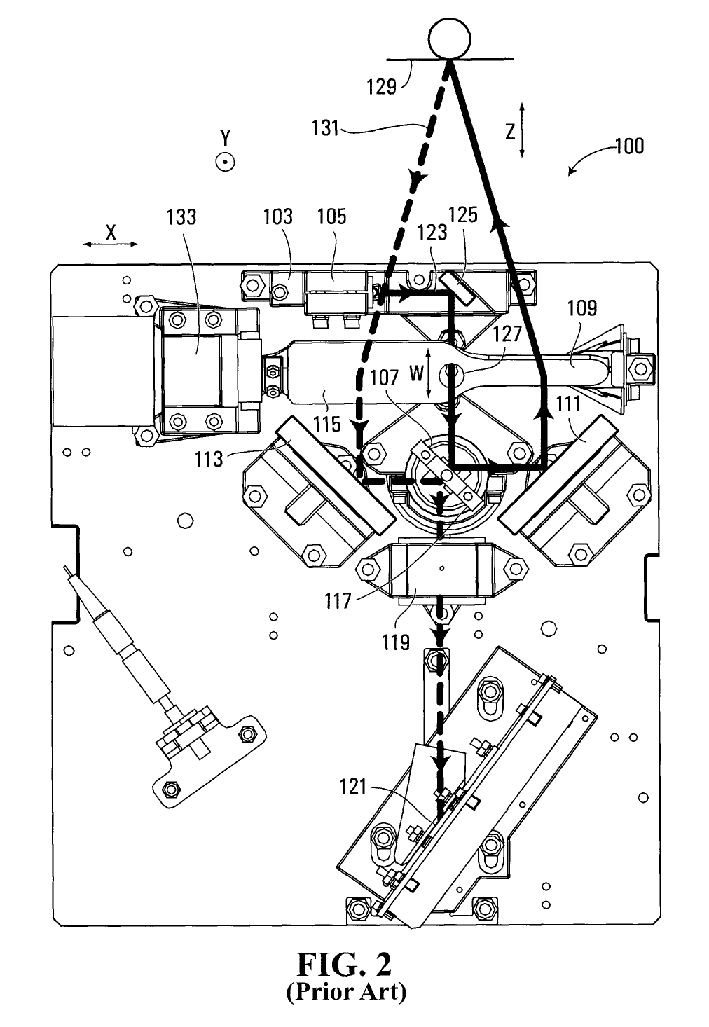

### DESCRIPTION OF EMBODIMENTS

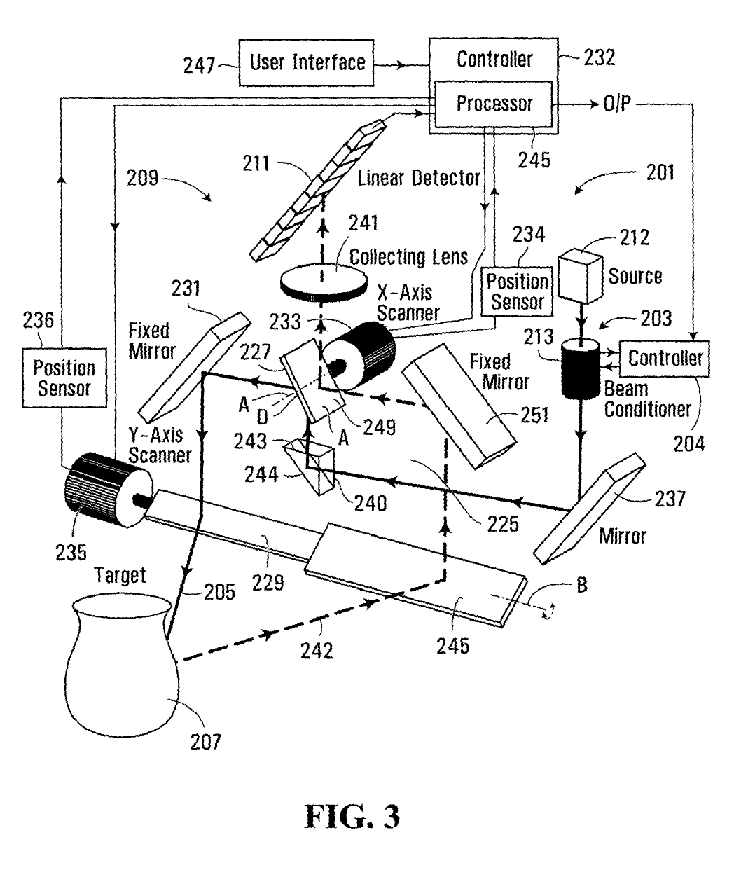

FIGS. 3, 4 and 5 show an example of an apparatus according to an embodiment of the present invention.

The apparatus generally shown at 201 comprises a projection system 203 for projecting a beam of energy 205 onto a target object 207, a receiving system 209 for receiving reflected beam energy from the target object 207 and a detector 211 for detecting the received beam energy.

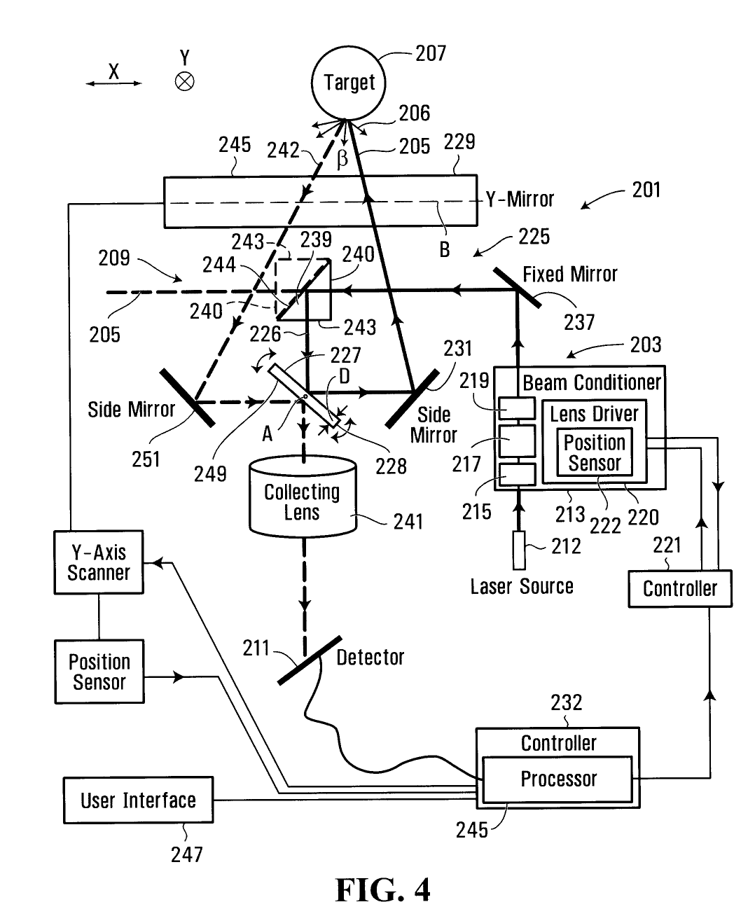

It will be appreciated that for a diffuse surface, the incident beam will be scattered in many different directions as for example shown by the ray lines 206 in FIG. 4, and a portion of the scattered radiation will be received by the receiving system and detected by the detector. The position of the received beam energy on the detector depends on the angle β between the projected beam and received reflected beam energy at the target surface. As the angle β depends on the range of the target surface, the position of the received beam energy at the detector provides a measure of the range.

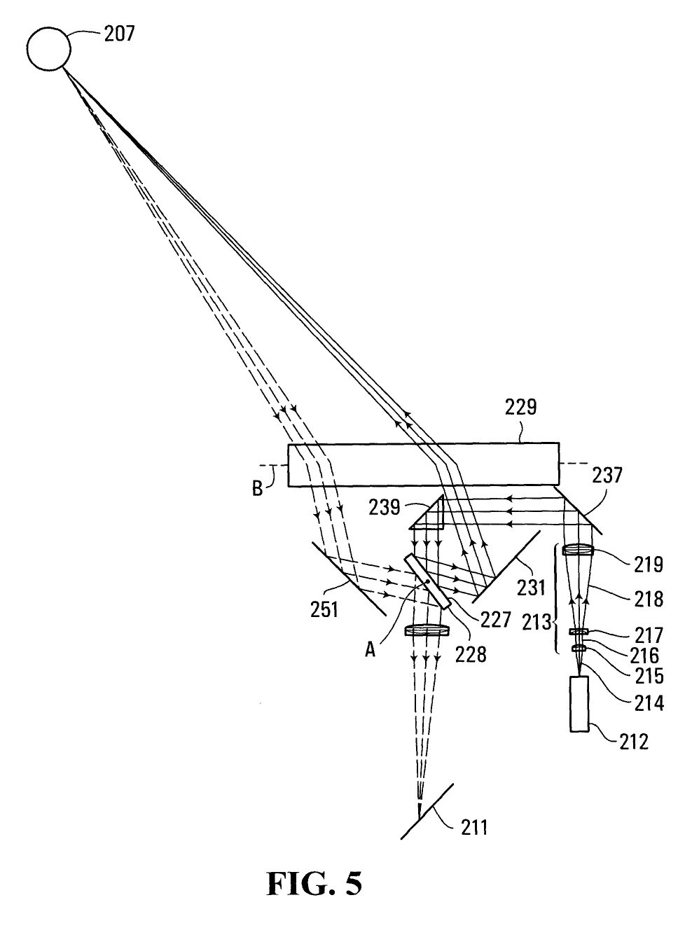

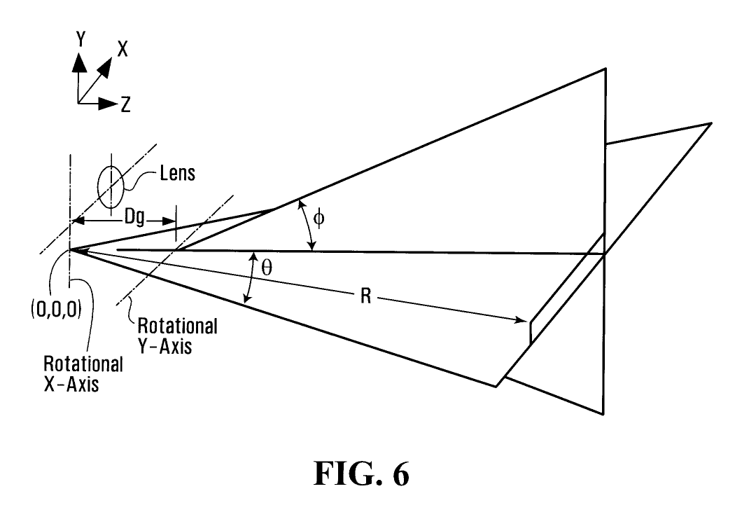

In this embodiment, the projection system comprises a source 212 of coherent electromagnetic radiation, such as a laser (e.g. a continuous wave (CW) laser) and a beam conditioner 213 for producing a focused beam of required spot size at a target surface. The beam conditioner comprises a means for providing a beam of relatively large diameter and introducing the beam to a focusing device for producing a focused beam to provide a relatively small diameter spot at the target surface. The beam conditioner may also allow the focal length of the beam to be varied. In the embodiment shown in FIGS. 4 and 5, the beam conditioner comprises a collimator 215 for producing a collimated beam, a beam expander 217 for expanding the width of the collimated beam, and a focusing device 219 for focusing the projected beam. The beam expander 217 may comprise any suitable device or arrangement for enlarging the width of the beam, and the beam expander may comprise a fixed beam expander by which the beam size is fixed and cannot be varied, or a variable beam expander to enable the beam width to be varied. This latter embodiment may be useful for controlling the width of the beam at the target surface, for example, for coarse and fine measurements.

The focusing device 219 may comprise a fixed focusing device by which the focal length of the beam cannot be adjusted, or may comprise a variable focusing device for varying the focal length of the beam. In this latter embodiment, the focusing device may comprise any suitable device for varying the focal length of the beam.

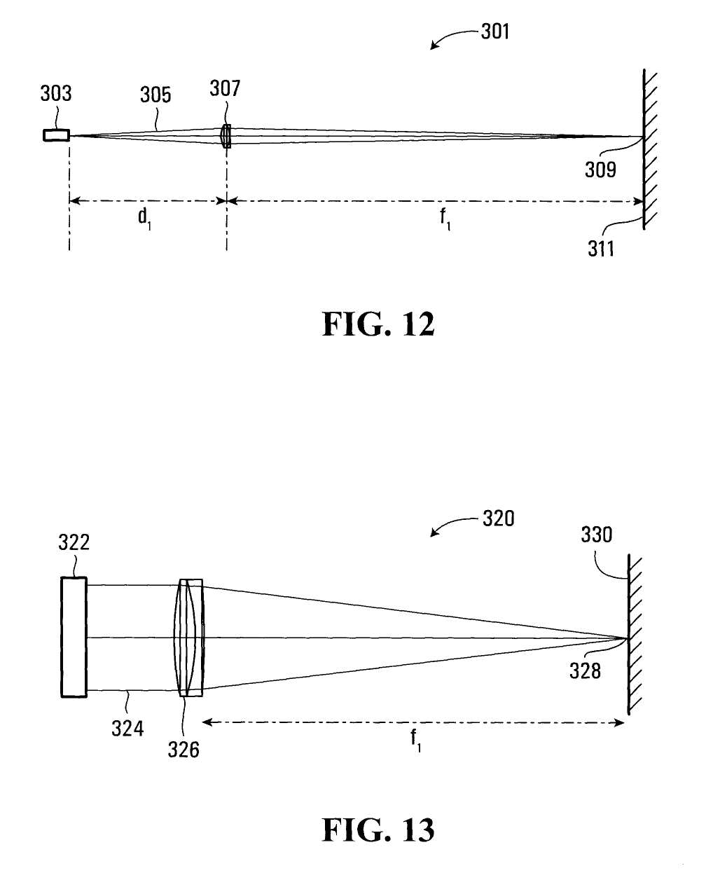

The source 213 comprises a single mode optical fiber providing a divergent beam 214 to a collimator 215. In this embodiment, the collimator comprises an optical lens element. The collimator collimates the divergent beam into a collimated beam 216 which is introduced to a beam expander 217. Referring to FIG. 5, the beam expander 217 comprises a lens 219 which is positioned to receive a collimated beam 216 from the collimator 217 and produce a divergent beam 218. The focusing device 219 is positioned to receive the divergent beam 218 from the beam expander 217, and is capable of focusing the beam at a target surface. The distance between the two lenses 217, 219 may be set either to collimate or focus the beam exiting the lens 219, and the distance may either be fixed or variable. The device may, for example comprise a Galilian device having a negative and a positive lens or a Keplarian device having first and second positive lenses. These and other examples of optical systems for the beam conditioner are described below with reference to FIGS. 12 to 15.

The purpose of the beam expander is to expand the beam to a relatively large size to enable the beam to be focused to a relatively small spot size at a target surface.

In one non-limiting example, the initial diameter of the beam from the source may be about 10 μm, and the collimated beam 216 may have a diameter of about 2 mm. The beam expander 217 may expand the beam to a size of 5 mm or more, for example any value from 8 to 25 mm or more at the focusing device 219, which can then focus the beam to a size of about 100 μm or less at a target surface.

Referring to FIG. 4, the beam conditioner 213 includes a driver 220 for changing the distance between the beam expander 217 and focusing device 219 to vary the focal length of the beam. The driver may be arranged to drive motion of the focusing device, the beam expander or both back and forth along the beam direction and, may comprise an electric motor, for example. A controller 221 is provided for controlling the driver, and a position sensor 222 is provided for sensing the position of the moveable element(s) (e.g. focusing device and/or expander) and to provide a signal indicative thereof to the controller 221 to complete the control loop. The beam conditioner controller 221 is operatively coupled to the main controller 232 to control operation thereof, as described in more detail below.

The projection system 203 further comprises a beam steering system 225 for controlling the trajectory of the projected beam. The steering system includes an x-scanning mirror 227 for moving the beam along the x-axis, a y-scanning mirror 229 for moving the beam along the y-axis and a side mirror 231 for directing the beam from the x-mirror to the y-mirror. The x-mirror 227 is mounted for rotation about an axis “A” which extends along the y-direction and the y-mirror 229 is mounted for rotation about an axis “B” which extends along the x-direction. (It is to be noted that references to the x and y axis/direction are used in the broad sense to denote two mutually perpendicular lateral directions that are also mutually perpendicular to the range direction. Therefore, the x and y directions could be any direction relative to a reference coordinate system having, for example, horizontal and vertical directions. In other words, the x direction may or may not correspond to a horizontal direction and the y direction may or may not correspond to a vertical direction.) The side mirror 231 is typically fixed at a predetermined angle, for example, 45°, although its position and/or orientation may be adjustable and set at any other angle. First and second drivers 233, 235 are coupled to drive rotation of the x and y-mirrors, respectively. The drivers may comprise any suitable motor or actuator, and in one embodiment, one or both drivers are controllable to be moved to and held in any one of a number of different positions so that the beam trajectory can be selected and changed, as required. One or both drivers are also preferably capable of performing a progressive scan in either direction and may allow the range of the scan to be selected arbitrarily in one or both directions. In one embodiment, one or both drivers 233, 235 comprises a galvanometer(s).

The scan position of each motor may be controlled by a controller 232, which provides signals containing scan position information to each scanner.

Each driver 233, 235 has an associated position sensor 234, 236, respectively, for sensing its rotational position and providing a signal indicative of the position to the controller 232 to complete a closed control loop. Other configurations for controlling the position of the scanning mirrors are possible and will be apparent to those skilled in the art.

In this embodiment, the projection system 203 further comprises a primary mirror 237 and a prism 239 for introducing the beam from the beam conditioning optics (e.g. collimator, expander and focusing device) to the beam steering system. In this embodiment, the prism has first and second faces 240, 243 perpendicular to each other and a rear face 244 adjoining the first and second faces at an angle of 45° thereto. The prism 239 is arranged so that the beam enters the prism through the first (front) face 240 (generally at an angle of 90° thereto), is reflected from the rear face 244 and exits the prism through the second (side) face 243 towards the x-mirror 227. As the effective support structure for the reflecting face of the prism is in front of the reflecting face (in contrast to a mirror in which the support structure is behind the reflecting face), the prism provides a compact means of introducing a wide beam into the beam steering system from the side between the x- and y-mirrors, and the lack of rear supporting structure helps to minimize interference with both the projected and reflected beams to maintain the field of view.

In one embodiment, the rear (hypotenusal) face of the prism may have a reflective coating. The coating may comprise any suitable material, for example aluminum or other material.

In another embodiment, the beam 205 may be introduced from the left-hand side, rather than the right-hand side, as shown by the broken lines 205 in FIG. 4. In this case the prism 239 or other reflector device, may be rotated through 180° relative to the solid line prism in FIG. 4, as shown by the broken lines.

In yet another embodiment, the prism 239 may be arranged so that the beam is incident on the outer face of the hypotenusal side with the body of the prism being positioned behind the hypotenusal face, as shown by the dotted lines in FIG. 4.

The inventors have found that, in some arrangements, this alternative orientation of the prism allows a larger scanning angle and total field of view (FOV).

In another embodiment, the prism may be replaced by a plate of transparent material having planar front and rear surfaces, with a reflective coating disposed on the rear face.

In general, the beam 205 is introduced into the beam steering section 225 along a plane which is generally transverse to the direction of the spacing between the x and y scanners (e.g. mirrors 227, 229). In another embodiment, the beam may be introduced at any other angular position about the beam axis 226 between the device 239 and x-scanner 227.

In other embodiments, the beam conditioning optics may be positioned so that the beam exiting therefrom is initially directed towards the prism, allowing the primary mirror 237 to be omitted.

The beam receiving system 209 comprises a steering system for steering the reflected beam from the target surface, a focusing device 241 and a beam detector 211. The beam steering system comprises a y-mirror 245 for moving the reflected beam 247 in the y-direction, an x-mirror 249 for moving the reflected beam in the x-direction, and a second side mirror 251 for directing the reflected beam from the y-mirror onto the x-mirror. In this embodiment, the y-mirror 245 for receiving the reflected beam is an integral part of the y-mirror for steering the projected beam 205 so that movement of both mirrors is synchronized and can be driven by the same driver or actuator. However, in other embodiments, the projecting y-mirror 229 and the receiving y-mirror 245 could be separate mirrors driven by separate drivers, or coupled together and driven by the same driver.

The second side mirror 251 is typically a fixed mirror and in this embodiment is angled at 45°, although in other embodiments, the side mirror may be mounted on an adjustable mounting mechanism so that its position and/or orientation can be varied.

The receiving x-mirror 249 is formed on the opposite side of the projecting x-mirror 227 and therefore the two mirrors move synchronously and are driven by the same actuator. In this embodiment, the reflective surface which constitute the x-mirrors 227, 249 are planar and parallel and the planar surfaces are positioned close together as indicated by the small spacing “D” therebetween. This geometry provides a surface area which is sufficient to accept a relatively large beam width while at the same time providing a compact and potentially lightweight structure.

The focusing device may comprise any suitable focusing device for focusing the reflected beam from the x-mirror onto the detector 221, and may for example comprise one or more lenses, and in one embodiment comprises a telescope arrangement. In some embodiments, the collection lens has a fixed focus, and the detector is angled so that the beam is focused at all positions on the detector.

The detector 211 comprises a position detector for detecting the position of the reflected beam. In one embodiment, the position detector comprises an array of sensors which are sensitive to the beam energy, for example, photo sensitive detectors. The detector may comprise a linear or an array detector. In other embodiments, the detector may comprise a position sensitive detector (PSD) (based on resistance measurements, for example). In one embodiment, position is detected by measuring voltage or current at each end of the detector and possibly comparing the measurements. For example, the position may be determined from the relation p=(A−B)/(A+B), where A and B are the values of the measured parameter (voltage or current) at the ends of the detector and using the measurements at both ends removes the dependency on beam intensity.

In another embodiment, the position detector may comprise a reflector for reflecting the beam onto a detector, where the position of the reflector is varied as the position of the beam changes to maintain the beam at a predetermined position on the detector, and the position of the beam is given by the position of the reflector.

A processor 245 may be provided to receive and process signals from the position sensitive detector 211. The processor may also be adapted to perform any one or more other functions which may include: controlling one or more of the x- and y-scanning mirrors and receiving signals indicative of the position of the x- and/or y-scanning mirror, receiving input commands from a user interface, e.g. a user interface 247 (FIGS. 3 and 4), for controlling operation of the imaging system, and controlling the beam expander and/or the variable focusing device to vary the focal length of the projected beam. The processor may also compute the coordinates of the target surface (e.g. the x, y and z coordinates) intercepted by the beam at any instant of time and provide an output indicative of the coordinates. The resulting output may be subsequently used in any desired manner, for example, the data could be stored, displayed or transmitted elsewhere, for example, for analysis. In other embodiments, one or more further processors may be provided to perform any of the above-mentioned functions or any other function.

The receiver system for steering the reflected beam copies movement of the projection beam steering system and the combined projection and receiving steering mechanisms remove the need to physically move the beam source with the beam detector to scan the beam across the surface. Thus, as indicated above, the position of the detected beam on the position detector provides the range of the surface (i.e. position in the z direction), and the positions of the x and y-mirrors provide the x and y coordinates of the beam at the surface.

### Controlling Beam Size

Embodiments of the invention provide a method of controlling the size of the beam at the target surface, and the method can be used for tightly focusing the beam at the target surface to increase the resolution of measurements in any one or more of the x, y and z directions. The method generally involves measuring a parameter for use in focusing the beam onto the target surface, projecting a beam of energy onto the surface and controlling the focal length of the beam based on the parameter to control the size of the beam at the surface. In one embodiment, the imaging system (for example as shown in FIGS. 3 to 5) is used to make a coarse or approximate measurement of the position of the target surface. In making such a measurement, the beam projection optics can be adjusted to project a beam having a relatively large diameter (of for example 1 mm or more) onto the target surface and the imaging system is used to measure the x, y and z coordinates of the surface, as described above. In making this approximate measurement, the beam size at the target surface may be sufficiently small to enable a range measurement to be made. For example, the beam size at the target surface may be such that the error of the measurement is within the focal depth of the beam when the beam is more finely focused to the desired size for the higher resolution measurement. Having determined the 3-dimensional coordinates of the target surface, the beam path length from the projection side focusing device to the target surface can then be determined, and this corresponds to the focal length of the beam required to focus the beam at the target surface. Alternatively, any other suitable method may be used to determine the required focal length. This information is then used to adjust the focal length of the beam to control the beam size at the target surface to enable, for example, higher resolution measurements to be made.

A similar procedure may be used to control the beam size at the target surface when the beam trajectory is moved to a new position, which may change the beam path length between the projection side focusing device and the target surface. On the other hand, if any change in beam path length does not significantly change the size of the beam at the target surface, further adjustment, such as refocusing the beam, may not be required.

Alternatively, or in addition, an indication of whether or not the beam is focused at the target surface may be determined using any other suitable technique. For example, a parameter indicative of whether the beam is focused at the target surface may be provided by the reflected beam, and this parameter may be detected by an appropriate detector. For example, the size of the reflected beam at the position sensitive detector 211 may be indicative of the size of the beam at the target surface and this information could be used to adjust the focal length of the projected beam. For example, the inventors have found that an unfocused beam at the target surface may result in the reflected beam at the position sensitive detector being spread over a relatively large area, and this information can be used to adjust the projection side focusing device.

In any embodiments, adjustments to the focal length of the projected beam may be made manually or automatically, for example, by a processor which receives a parameter indicative of whether the beam is focused and which provides a control signal in response thereto to adjust the focal length.

Table 1 shows various values of beam spot diameter in microns as a function of range for a number of different values of beam width before focussing the projected beam, i.e. the exit beam size. The values of spot diameter are minimum values assuming an ideal Gaussian beam. As shown, the beam spot diameter can be made smaller by increasing the beam width at the focussing device. Embodiments of the apparatus may be adapted to provide a value of beam spot size at a target surface having any of these values, or other values within or outside the range of values provided in the table. The table illustrates that resolution of less than 500μ can readily be obtained by using a beam width before focussing of 5 millimeters or more. The minimum spot size depends on the range. In some applications, embodiments of the apparatus may be used to make measurements over a range dimension of between 0.5 m and 2 m, and in other applications, embodiments may be used for longer and/or shorter range measurements. Positioning the apparatus at increased distances from the object may assist in increasing the field of view.

spot size (1/e\hat{ }2) on target depending on beam exit size and range

| D in mm | | | | | | |
|---|---|---|---|---|---|---|
| (spot size of | Range (m) | | | | | |
| 1/e\hat{ }2 at exit lens) | 1 | 2 | 3 | 4 | 5 | 10 |
| 5 | 161 | 321 | 482 | 650 | 794 | 1534 |
| 7.5 | 107 | 215 | 322 | 429 | 536 | 1064 |
| 10 | 80 | 161 | 242 | 322 | 403 | 804 |
| 15 | 54 | 107 | 161 | 215 | 269 | 537 |
| 20 | 40 | 81 | 121 | 161 | 201 | 403 |
| 25 | 32 | 65 | 97 | 129 | 161 | 323 |

In embodiments of the apparatus which allow beam steering in at least one lateral direction, equations for determining the values of x, y and z of a target surface are given in “J.-A Beraldin, SF El-Hakim and L. Cournoyer” Practical range camera calibration Proc. SPIE 2067, 21-31 (1993), the entire content of which is incorporated herein by reference.

FIG. 11 shows a simplified geometrical model of an embodiment of the apparatus. Referring to FIG. 11, parameter, R, is the range and corresponds to a distance between the axis of rotation of the x-scanning mirror and a point, P, θ is the angle of rotation of the x-mirror and Φ is the angle of rotation of the y-mirror. As shown in FIG. 11, the rotational axis of the y-mirror is displaced from the rotational axis of the x-mirror by a distance Dg, and this displacement between the x and y axes results in an astigmatism so that θ, Φ and R are not real spherical coordinates. In a real spherical coordinate system, as implemented in a pan-tilt unit for example, the rotational axes of the x and y-mirrors cross at the origin where the light source is located.

In some embodiments, a signal provides a measure of the angular position of the x and y scanning mirrors and the signal may for example be x and y galvanometer voltages (u) and (v), respectively. The position of the beam at the detector may be provided by a signal indicative of the pixel number of a detected peak on the array (P). In order to obtain the x-mirror rotation angle θ, the y-mirror rotation angle Φ and the range R of an object as shown in FIG. 11, a white calibration board with black dots with known separation between the dots is placed in front of the apparatus at a known range location. By comparing images produced with u, v and P, as parameters, to the real range data and the angle between dots, a set of calibration parameters is produced, which can be used to convert u, v and P into θ, Φ and R values.

The quasi-spherical coordinates θ, Φ and R can be converted into Cartesian coordinates, x, y and z using the following equation which also corrects the astigmatism caused by the separation Dg of the x and y rotational axes:

$$[ \begin{matrix}x \\ y \\ z\end{matrix} ] = R \cdot [ \begin{matrix}\begin{matrix}sin ( θ ) \\ ( cos ( θ ) - ψ ) sin ( φ )\end{matrix} \\ ( 1 - cos ( φ ) ) Ψ + cos ( θ ) cos ( φ )\end{matrix} ]$$

where ψ=Dg/R.

This equation and additional details are described in Blais, F., Beraldin, J.-A., and El-Hakim, S. F., “Range error analysis of an integrated time-of-flight, triangulation, and photogrammetry 3D laser scanning system,” SPIE Proceedings of AeroSense, Vol. 4035, Orlando, Fla. April 24-28 (NRC 43649): SPIE, 2000.

Thus, the calibration process converts voltages (u, v) of the galvanometers that drive the x and y-mirrors and the peak location (P) on the detector array into Cartesian coordinates, x, y and z. This enables the apparatus to measure the three-dimensional location of any point of a target object.

In practice, there can be a small dependence of the position of the image on the detector on the x and y mirror position, which may be resolved by calibration using any suitable technique, for example, curve fitting, using a calibration look-up table, or by analytical calculation.

### Speckle Noise

Advantageously, the apparatus according to embodiments of the present invention allows the beam size at the target surface to be significantly reduced in comparison to known instruments, particularly those which are based on the triangulation method, and this assists in substantially reducing speckle noise and increases the accuracy and resolution of the device.

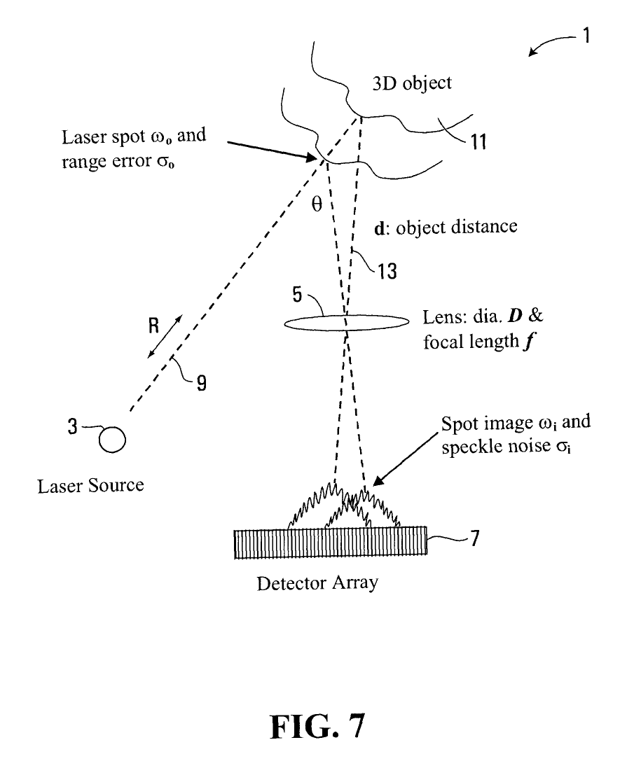

Speckle noise arises when a coherent laser beam is reflected from a surface that is rough, compared to the laser wavelength. In the triangulation method, speckle noise causes the image of the laser spot on the linear array to deviate from a smooth shape due to modulation of its peak by the interference pattern of the speckle, as for example shown in FIG. 7. As a result, the center of the peak cannot be determined with a high degree of accuracy, reducing the quality of the range measurement.

Speckle noise depends on wavelength, polarization and the length of the optical path. Time averaging cannot reduce speckle noise if the above parameters are not varied over time. The standard techniques to reduce speckle noise are spatial averaging, polarization and spectral averaging. Spatial averaging is commonly used in non-imaging applications. This usually involves rotating the target to divert the beam. This allows averaging of the interference pattern within the integration time of the detector. For imaging applications, this approach sacrifices the imaging spatial resolution. In spectral averaging, the interference patterns produced by different wavelengths are out of phase. If the roughness of the surface is h, the required wavelength difference must be Δλ=λ²/h. Given that the most commonly machined surfaces have a roughness from 0.1 μm to 10 μm, the required Δλ is approximately 4,000 nm to 40 nm at a wavelength, λ of 632 nm. Most semiconductor lasers do not have a spectral width wide enough to average out the speckle. Speckle noise can be reduced if the speckle over two orthogonal states of the polarization is averaged. This approach requires physically rotating the polarizers and is difficult to implement.

Given the difficulties and compromises involved in common speckle reduction techniques, an effective approach is provided by embodiments of the present invention, which provide an arrangement for producing a relatively large diameter beam and a focusing device for focusing the beam onto the target surface.

The spot size ω₀ (radius at 1/e²), (where ‘e’ is the natural logarithm) at the target surface can be estimated by the diffraction limit of the lens given by the equation:

ω₀=0.61·λ·R/Φ Eq (1)

where λ is the wavelength, Φ is the size of aperture of the launching optics, and R is the range. If R is between 1 and 2 meters and Φ is 25 mm, a beam width of about 50 μm can be achieved at the target surface by choosing an appropriate wavelength. Using a lens with a focal length, f, and diameter D, to image a laser spot, ω₀, on a target with the return signal on the detector array having a spot size of ωᵢ, the statistical error of the center of the peak of the image, σᵢ is given by the following equation:

$${σ}_{i} = \frac{1}{2} \sqrt{{ω}_{i} \cdot λ \cdot f / 2 D} \qquad Eq ( 2 )$$

If d is the object distance, the image error can be translated into a range error, given by the equation:

$${σ}_{0} = \frac{1}{2 Sin θ} \sqrt{{ω}_{0} \cdot λ \cdot d / 2 D} \qquad Eq ( 3 )$$

The ratios of ω₀/ωᵢ and d/f are equal to M, the magnification factor of the lens. The angle between the projecting beam and the returned beam is θ. By decreasing the spot size from 1 mm to 50 μm, the speckle noise on range is reduced by a factor of √20.

Thus, advantageously, embodiments of the present invention allow the speckle effect to be significantly reduced without involving the complexity of common speckle reduction techniques. Advantageous embodiments may be realized by choosing appropriate values of the parameters ω₀, λ, f and D. Parameters D and f are related to camera range, detector size and light collecting efficiency. Small values of λ can be achieved by selecting lasers with short wavelengths, and small values of ω₀ can be achieved with proper focusing optics, at the projection side.

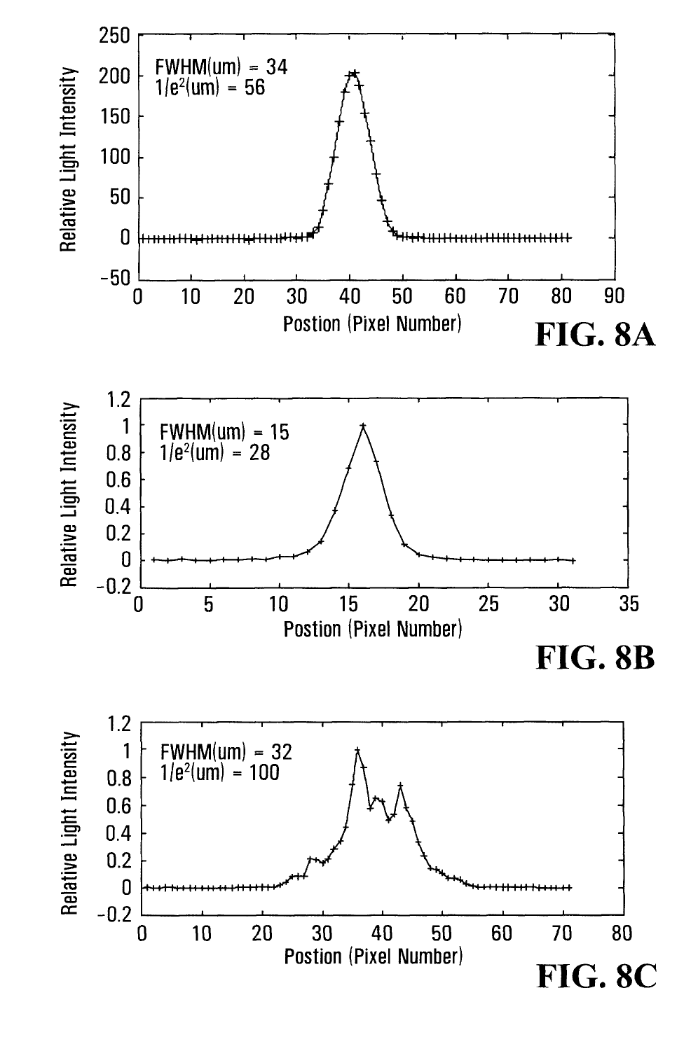

Speckle noise can only be detected by a detector if ωᵢ is bigger than the diffraction limit of the lens. Advantageously, improvements may be achieved by selecting a small ω₀ and a proper value of M to make ωᵢ close to the spot size of the collecting lens diffraction limit. For example, in a system using 1000 nm wavelength, a lens of f/D=5, M of 7, the laser spot on the target, 2ω₀ is 56 μm, as shown in FIG. 8A. The spot size on the detector, ωᵢ, equals 4 μm, which is close the Airy disc size of the lens given by the equation:

$$ω = 0.61 \cdot \frac{f}{D} \cdot λ = 3.1 µm \qquad Eq ( 4 )$$

The speckle noise is not visible if the spot is imaged by an array with a pitch of 5 μm, as shown in FIG. 8B. However, if ω₀ increases to 700 μm, the speckle noise becomes large enough to seriously compromise the peak detector algorithm, as shown in FIG. 8C. In FIG. 8A, the y-axis is relative light intensity and in FIGS. 8B and 8C, the y-axis is normalized light intensity.

One way to make the diffraction limit of the lens match the width of the detected beam, ωᵢ, is to add a smaller aperture over the collection lens. If a detector array is used to detect the image spot, in order to achieve sub-pixel resolution when the peak center can be interpolated by power distribution for more than 2 pixels, modeling has shown that the pixel width of the detector array should be less than ωᵢ.

Alternatively, or in addition, tighter focusing could be provided by selecting a shorter wavelength of the laser beam. (Generally, shorter wavelengths produce a smaller spot size).

### Edge Effects

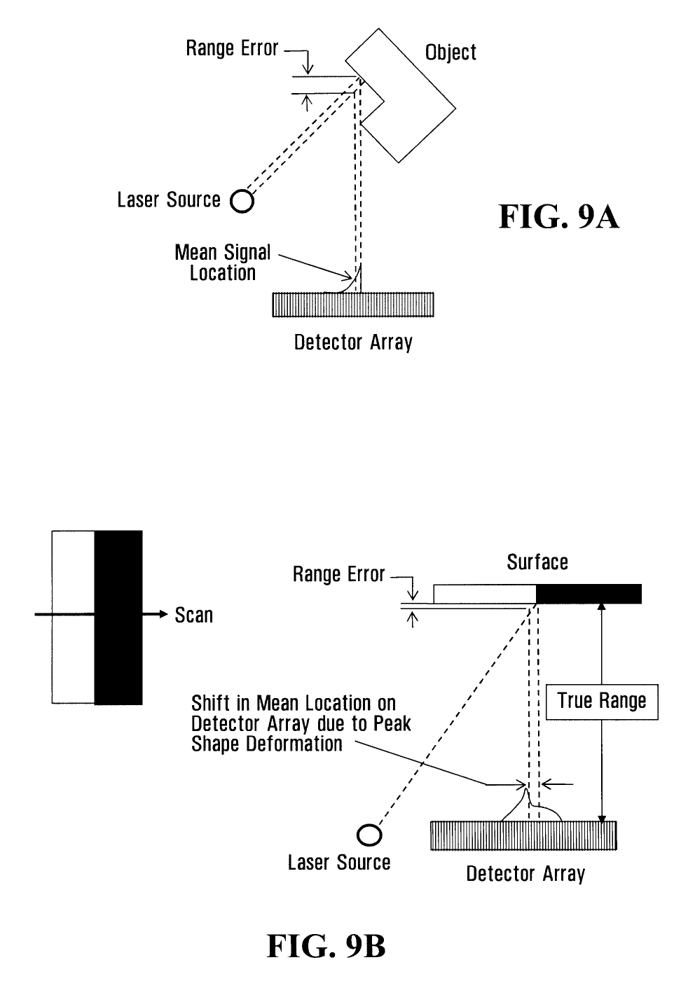

Edge effects occur when a beam spot is split by a physical edge on two surfaces, or crosses a reflectance change at an interface between two surfaces on the same plane. When a laser spot is split between two surfaces at different ranges, the image of the spot on the detector array is the combined signal at two distances. Its peak center does not represent either ranges of these surfaces, as shown for example in FIG. 7. The center peak of a spot image can also be distorted when the returned beam is blocked by an edge, as shown in FIG. 9A, or the reflectance at an interface varies, as shown in FIG. 9B. There are many cases where edge effects can arise. Advantageously, the ability to focus the projected beam to a small beam size at the target surface provided by embodiments of the present apparatus enable errors due to edge effects to be significantly reduced.

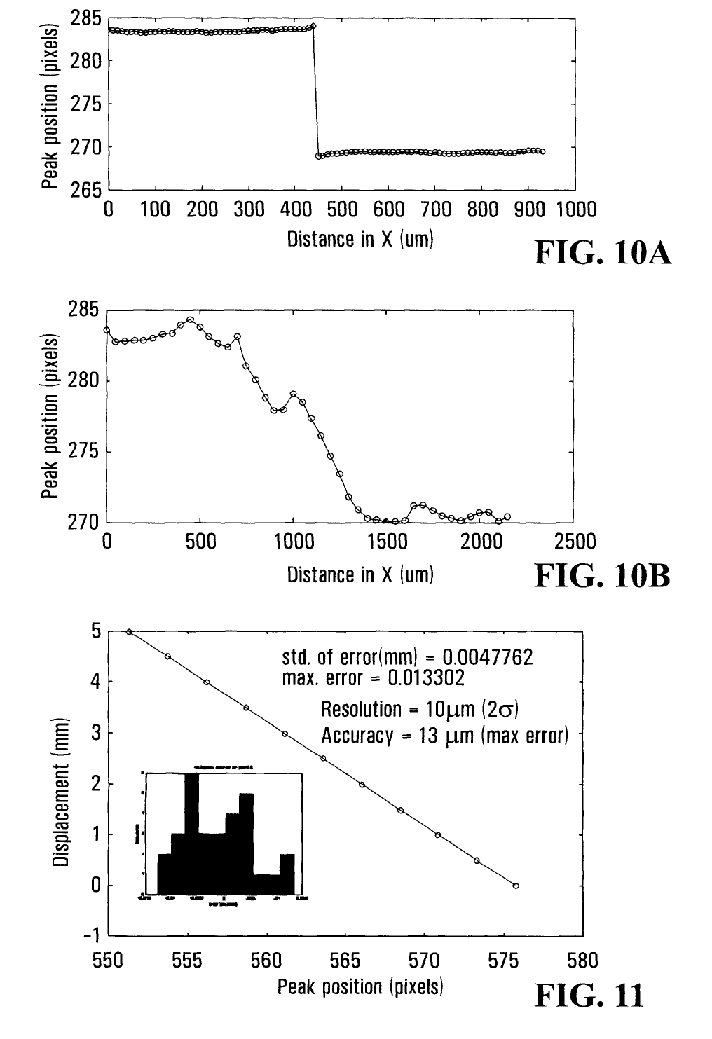

An example of the improvements in reducing edge effect errors provided by an embodiment of the imaging apparatus over a conventional 3-D triangulation based imaging instrument can be appreciated with reference to FIGS. 10A and 10B. In this experiment, the edge of a micrometer head with a height of 3 mm was scanned. Each figure shows a graph of detected peak position as a function of distance (i.e. scan position). In FIG. 10A, a laser spot having a diameter of 50 μm and a lateral scanning step of 10 μm were used. As can be seen from the figure, edge induced range errors are on the order of 10 μm and the lateral edge can be determined on the 10 μm step as well.

In FIG. 10B, a laser spot of 1 mm and a lateral scan step of 50 μm were used. In this case, the location of the edge cannot be determined accurately. The range error on the flat part of the graph is about 300 μm due to speckle noise.

### Range Resolution and Accuracy

With a reduction in speckle noise and edge effects, the range resolution and accuracy of an embodiment of the 3-D laser camera was studied by mounting a target on a precision stage. The stage is moved with an accuracy of +/−1 μm as measured by a digital micrometer. FIG. 11 shows a comparison between measurements made by an embodiment of the present apparatus and the digital micrometer. Over a range of 5 mm (a limitation of the digital micrometer), 11 points were measured and compared. The maximum discrepancy between the digital micrometer and the imaging apparatus is 13 microns, which is the range accuracy of the imaging apparatus at a range of 1 meter. The middle point measurement was repeated 30 times, resulting in a standard deviation of 4.8 μm. The range resolution was found to be 10 μm, defined as a 2σ standard deviation resolution. Combined with the resolution measured on the lateral location of an edge, as shown in FIG. 10A, the resulting resolution of the imaging apparatus is in the range of 20 μm.

As can be seen from the above results, embodiments of the apparatus can significantly increase measurement resolution and reduce the effects of speckle noise and edge effects.

### Selective Access Scanning Method

In conventional 3-D imaging systems, an object is progressively scanned using a constant pitch or spacing between points on the surface of the object from which measurements are taken, and the systems acquire large quantities of 3-D data from the object which is subsequently analyzed to find a particular feature. Large amounts of processing time are required to sift through the data and locate the data which is relevant to the required measurement.

Systems and methods according to embodiments of the present invention enable a sequence of measurements to be made, where the position on the object at which each measurement in the sequence is made can be individually selected. This technique significantly reduces the time required to take a measurement by both reducing the number of data points measured, and reducing the time necessary to locate, in the data, the feature of interest and determine its position. This technique also helps to reduce the amount of storage or memory space required to store the data or the time to transmit the data.

In one implementation, the method may comprise determining or identifying an area of interest on an object, for example, either by means of performing a coarse scan to identify the area of interest or by using another instrument such as a 2-D camera, and performing a measurement in the area of interest to collect data points of the required accuracy and resolution. The system and method has wide application in the manufacturing sector for the measurement and verification of critical geometric features of a part or object. This data may be used for quality assurance or statistical process control purposes. It is highly desirable to have these verification processes performed in line with the production process to provide results as quickly as possible. Likewise, the verification process should not limit the rate of production of the parts. Embodiments of the system and method enable the dimensions between two points, two edges, two surfaces or any other geometric feature to be measured with high resolution and speed. Specific examples of embodiments of the system and method are described below.

In one embodiment, a series of coarse measurements are made by the imaging apparatus and from these coarse measurements, one or more features of interest are selected for further measurement. The coarse measurements give the approximate location of the features of interest. The coarse measurements may be made by obtaining relatively few data points on the object, possibly using a beam width at the target object that provides relatively low resolution measurements. For example, a beam width of 1 mm could be sufficient for some measurements. Alternatively, or in addition, a 2-D imaging camera could be used to obtain information about the location of the features of interest, and this information could be used to control further measurements. In other embodiments, a coarse measurement could be made using a beam size at the target surface small enough to yield higher resolution measurements. However, in the coarse measurement, the density of fine measurements may be relatively low.

After the feature or area of interest on the object has been identified and its position located, the focal length of the beam may be controlled to set the beam size at the target surface to provide the required resolution using information about the position of the feature to be more closely examined, and a required series of beam positions on the target object may be determined for the further (possibly finer) measurements. The beam system is then controlled to direct the beam sequentially at the determined positions on the target surface and positional data about the feature is collected. Other features or areas of interest may be similarly measured.

The process of 3-D measurement can be very fast and can maintain acquisition rates of greater than 10,000 points per second. Embodiments of the present invention may be adapted to measure positions within a relatively large working volume, e.g. 1 to 2 m³ or more, and in one embodiment, the scanner has a field of view of 30° horizontal and 30° vertical and up to 2 meters range from the scanner.

As indicated above, an imaging camera may be collocated with the scanner optics, and may provide the same or a similar field of view. The camera can provide additional information on parts in the field of view of the scanner. For example, the camera could provide visual feedback and data used to plan the trajectory of the 3-D scanner.

In some embodiments, the apparatus may include means for identifying an object to be measured. The identifying means may be a means for reading a part number or bar code or for identifying a particular feature of the part or object from which it can be identified. The apparatus may further include recording means for recording the object identification information with the dimensional measurements made by the apparatus.

As indicated above, the precision of each 3-D point measurement can be controlled through focusing the laser beam to a small point, for example as small or smaller than 35 μm FWHM (full width half maximum). The beam expander may be controlled to adjust the laser focusing to any point in the working volume. The control of the laser spot size on the part allows finer spatial measurements to be made. The reduction in spot size also reduces the effect of speckle noise of the return diffuse laser collected by the scanner and also reduces edge effects. Advantageously, the required power of the laser can also be reduced by focusing the laser beam onto a small point or area. In some embodiments, the laser power may be controlled by the scanner on a per-point basis. If the material surface of a part is specular in nature and deflects the laser away from the scanner, the scanner can control the laser power to ensure a proper signal-to-noise ratio on its measurements and avoid saturation on the linear detector.

In operation, a part to be measured is moved into the measurement volume of the scanner. Advantageously, the part does not have to be precisely located or oriented with respect to the scanner. The scanner could be placed statically in place, for example, on a suitable support such as a tripod or other support for the entire measurement task. No support structure is required to move the scanner closer to the part to obtain a high degree of precision in the measurements.

Advantageously, the selective access feature of the scanner allows for great flexibility in performing various kinds of part measurements. For example, in measuring the flatness of a plane, the scanner can distribute a small number of point measurements, (for example 100 or less) over a large area in a small amount of time. Likewise, to measure the width of a part, the scanner could acquire the data directly at the edges of the part. Furthermore, since the acquired data is 3-dimensional, the scanner can perform measurements to verify geometrical tolerances, for example the degree of parallelism between two parallel planes, concentricity, orthogonality or other geometrical relationship, that other optical non-contact sensors would have difficulty collecting.

In some embodiments, a data processor may be provided to compare data derived from measurements of an object using the apparatus with data derived from another source, for example a computer generated model of the object. Such a comparison of data could be made as the measurements are being made. This allows the accuracy of a manufacturing process in producing an article to be checked against a predetermined standard, for example.

Embodiments of the apparatus have the ability to focus a beam of energy onto a target surface so that the incident spot size is small and allows high resolution measurements to be made. There are numerous optical arrangements that can be used to generate a focused beam at a target surface. Embodiments of the apparatus further provide the ability to vary the focal length of the beam so that high resolution measurements can be made at any one of a number of positions within a relatively large volume of 3-D space, for example 1 m³. Again, there are numerous optical arrangements which can be used to provide such variable focusing, and any suitable arrangement may be used in embodiments of the apparatus, without limitation. A few non-limiting examples of various optical arrangements for providing focusing and/or variable focusing of a beam at target surface are described below with reference to FIGS. 12 to 15.

Examples of a suitable optical source include a divergent beam provided, for example, by a single mode (SM) fiber, and a collimated beam, for example, provided by a HeNe laser. The beam from a single mode fiber typically has a size of about 10 μm and a divergence angle which ranges from about 15° to 45° (full angle). Optically, these two types of beams are related and can be converted to each other. Only a well collimated beam can be focused into a very small spot, and conversely, only a beam emitted from a very small spot can be shaped into a well collimated beam. As indicated above, there are numerous systems (different lens combinations) that can provide a focused spot on a target with a variable focal length.

Referring to FIG. 12, an optical system 301 comprises a source 303, for example a single mode fiber providing a divergent beam 305 and a single, positive lens 307 for focusing the beam at a focal point 309 which is coincident with a target surface 311. The focal length f₁ of the beam can be varied by varying the distance, d₁ between the source 303 and lens 307 by moving the source or the lens or both. The system may be such that relatively small changes in the distance d₁ provides a relatively large change in focal length and therefore a means of finely adjusting d₁ over a small range of motion may be required. It is also important that movement of the source or lens does not change the angle of the beam from the lens.

Referring to FIG. 13, an optical system 320 comprises a source 322, such as a HeNe laser, providing a collimated beam 324 and a single lens 326 for focusing the beam to a focal point 328 coincident with a target surface 330. Although this arrangement is useful for focusing a beam to a small spot size at a target surface, the focal length, f₁, is fixed rather than adjustable.

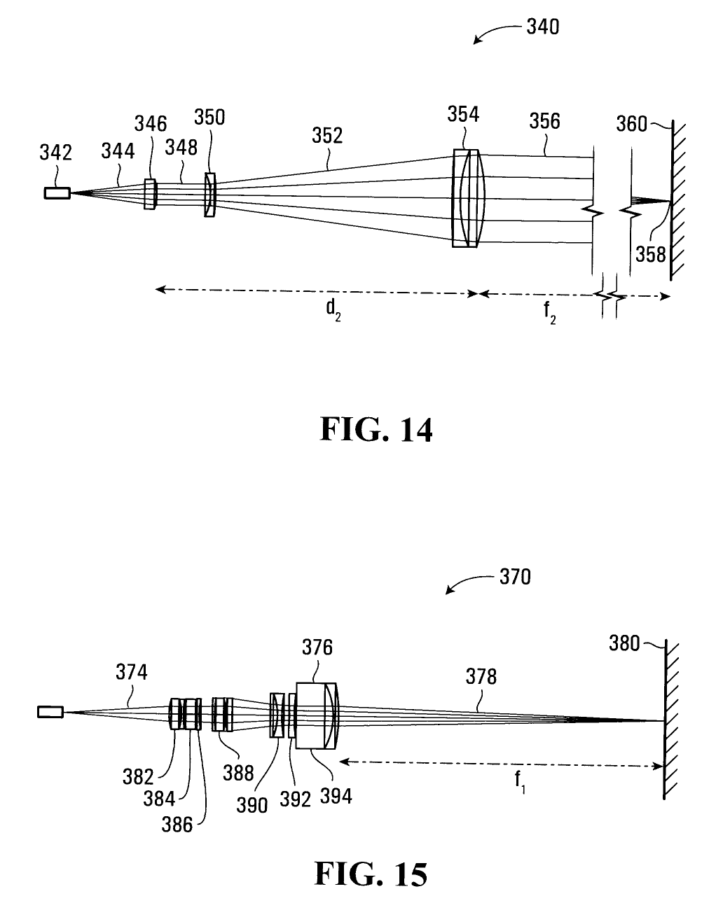

Referring to FIG. 14, an optical system 340 comprises a source 342, such as a single mode fiber, providing a divergent beam 344, a lens 346 for receiving the divergent beam 344 and providing a collimated beam 348, a second lens 350 for receiving the collimated beam 348 and producing a divergent beam 352, and a third lens 354 for receiving the expanded, divergent beam 352 and producing either a collimated or focused beam 356. In this embodiment, the second lens 350 produces an imaginary focal point on the left-hand side of the lens (not shown) and is therefore a “negative” lens. On the other hand, the first lens 346 is a positive lens providing a collimated beam whose focal point is at infinity at the right-hand side thereof, and the third lens 354 is also a positive lens.

In order to vary the focal length f₂ of the beam 356 from the third lens 354, the distance, d₂, between the second and third lenses 350, 354 is varied and this may be achieved by moving the second lens or moving the third lens, or both. Advantageously, in comparison to the arrangement of FIG. 12, in the arrangement of FIG. 14, the focal length f₂ is less sensitive to changes in the distance d₂ between the second and third lenses which facilitates the ability and the implementation of a mechanism to finely control the focal length. This arrangement is also less susceptible to producing changes in beam angle from the third lens.

In an alternative arrangement to FIG. 14, the second lens may be replaced by a positive lens which focuses the collimated beam at a position beyond the lens but in front of the third lens 354. Thus, this arrangement has the effect of essentially extending the distance between the second and third lenses in contrast to the arrangement of FIG. 14, where the focal point of the second lens is to the left in the diagram. Accordingly, the arrangement of FIG. 14 allows the optical system to be more compact in the beam direction. Any suitable system may be used to moveably mount the moveable lens(es), and in one example, the lens is mounted for only linear movement in the beam direction. Some mechanisms exist which also rotate the lens as the lens is moved in the beam direction, but if the lens is not mounted symmetrically, rotation thereof may cause slight changes in the angle of the beam emitted from the lens.

Another optical system which may be used to provide a highly focused projected beam at a target surface is a zoom lens, an example of which is shown in FIG. 15. The optical system 370 shown in FIG. 15 comprises a source 372 such as a single mode fiber providing a divergent laser beam 374 and a zoom lens 376 for receiving the divergent beam 374 and producing a focused beam 378 on a target surface 380. The conventional function of a zoom lens is to produce a magnified image of a subject on a film or CCD (charged couple device) of a camera or at the eyepiece of a telescope. Embodiments of the imaging system use a zoom lens in reverse by providing a light source, e.g. bright spot, at the film or CCD location and using the zoom lens to project a focused spot on a target. The zoom lens may comprise any suitable zoom lens design, and in the present exemplary embodiment shown in FIG. 15, the zoom lens comprises a plurality of lens elements 382, 384, 386, 388, 390, 392, 394. The zoom lens includes a variable focusing arrangement which allows the focal length f₁ between the final lens element and the target surface to be adjusted. The zoom lens may have the ability to automatically maintain focus as the zoom is adjusted, and/or the focus may be independently adjustable from the zoom.

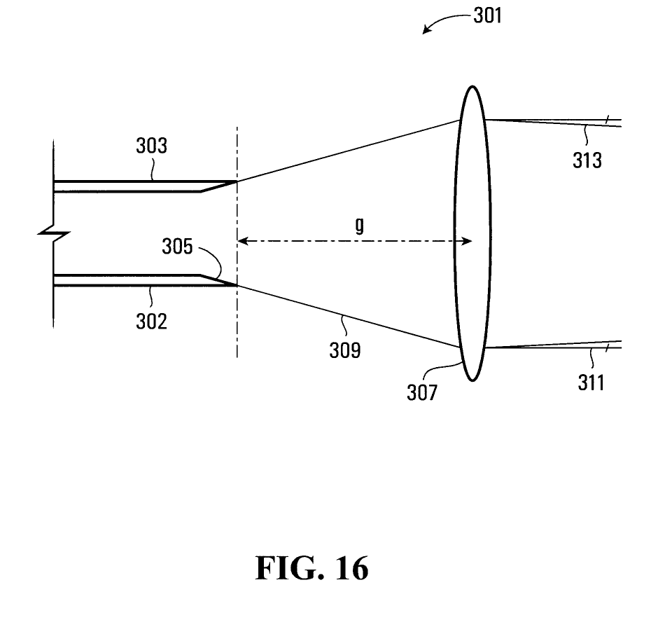

FIG. 16 shows a beam expander according to an embodiment of the present invention. The beam expander 301 comprises a waveguide 302 having an output for outputting a beam. The output 305 of the waveguide (e.g. optical fiber) is shaped to allow the beam to diverge into a divergent beam 309, for example. The beam expander further comprises a lens 307 for receiving the divergent beam 309. The lens can produce either a collimated beam 311 or a convergent beam 313 (or possibly a divergent beam). The size of the beam at the output of the lens can be varied by varying the distance g between the output of the waveguide 302 and the lens 307. The focal length of the beam can also be adjusted by varying the distance g. The focal length could be variable from any focal length to infinite (for a collimated beam). In another embodiment, a further device such as an apertured plate either before or after the lens could be used to vary the beam width. In addition, or alternatively, the shaping of the output of the waveguide could be set to vary the angle of divergence of the beam from the output of the waveguide to vary the beam width, for example.

The beam of energy may comprise electro-magnetic radiation, in the optical or non-optical part of the spectrum, and may be coherent or non-coherent. In one embodiment, the beam source may comprise an Erbium-doped fiber amplifier (EDFA) which produces non-coherent radiation. As speckle noise at least partially results from a coherent beam, the use of a non-coherent beam may beneficially reduce speckle noise.

Other embodiments of the invention comprise any feature disclosed herein in combination with any one or more other feature(s). In any aspect or embodiment of the invention, any one or more features may be omitted altogether or substituted by another feature which may be an equivalent or variant thereof.

Modifications and changes to the embodiments described above will be apparent to those skilled in the art. Any feature described herein may be substituted by another similar feature either having a similar function or manner of operation, a similar structure or providing a similar result.

1. An apparatus comprising a projection system for projecting a beam of energy onto a target surface, a receiving system for receiving reflected beam energy from the target surface, a detector for detecting the received energy;
wherein the projection system comprises a beam expander for receiving a beam of energy and expanding the width of the beam, and a focusing device for focusing the projected beam.

2. An apparatus as claimed in claim 1, wherein said beam expander is capable of expanding said beam to a beam size of 5 millimeters or more.

3. An apparatus as claimed in claim 2, wherein said beam expander is capable of expanding said beam to a size of 10 mm or more, 15 millimeters or more, 20 millimeters or more, or 25 millimeters or more.

4. An apparatus as claimed in claim 1, wherein said focusing device is capable of focusing said beam to a width of 500 microns or less, 400 microns or less, 300 microns or less, 200 microns or less, 100 microns or less, 75 microns or less, 50 microns or less, or 25 microns or less.

5. An apparatus as claimed in claim 1, wherein said beam expander comprises a variable expander for varying the size of the beam.

6. An apparatus as claimed in claim 1, wherein said focusing device comprises a variable focusing device for varying the focal length of the projected beam and/or the size of the beam at the target surface.

7. An apparatus as claimed in claim 1, wherein said detector comprises a position detector for detecting the position of the received reflected beam, wherein the position is dependent on the angle between the incident and reflected beam energy at the target surface and thereby on the distance between said apparatus and the position from which said beam is reflected from said surface.

8. An apparatus as claimed in claim 7, wherein the position detector comprises a plurality of beam sensitive sensors.

9. An apparatus as claimed in claim 5, wherein said detector comprises a position detector for detecting the position of said received reflected beam, wherein the position is dependent on the angle between the incident and reflected beam energy at the target surface and thereby on the distance between said apparatus and the position from which said beam is reflected from said surface, and said apparatus further comprises a controller for controlling the variable beam expander and/or the variable focusing device based on the detected position.

10. An apparatus as claimed in claim 1, wherein said detector comprises a position detector for detecting the position of the received reflected beam, wherein the position is dependent on the angle between the incident and reflected beam energy at the target surface and thereby on the distance between said apparatus and the position from which said beam is reflected from said surface, and said apparatus further comprises a controller for controlling the size of the beam at the target surface based on said detected position.

11. An apparatus as claimed in claim 1, wherein said focussing device comprises a zoom lens.

12. An apparatus as claimed in claim 11, further comprising determining means for determining the distance between the apparatus and the position of the beam at said target surface based on said detected position, and wherein said controller is adapted to control the beam size at the target surface based on the determined distance.

13. An apparatus as claimed in claim 12, wherein at least one of said beam expander and said focussing device is variable and said controller is adapted to control the beam size at the target surface by controlling said beam expander and/or said focussing device.

14. An apparatus as claimed in claim 13, further comprising a beam steering system for steering the projected beam to intercept said target surface at a plurality of different positions, and wherein said controller is adapted to control the beam size at the target surface at each of a plurality of different positions.

15. An apparatus as claimed in claim 14, wherein said controller is adapted to maintain said beam size at said target surface within a predetermined range, or at substantially the same predetermined value for each different position.

16. An apparatus as claimed in claim 1, further comprising a collimator for collimating said beam.

17. An apparatus as claimed in claim 16, wherein said collimator is positioned upstream of said beam expander in the beam direction.

18. An apparatus as claimed in claim 1, wherein said projection system further comprises a beam steering system for steering said projected beam.

19. An apparatus as claimed in claim 18, wherein said beam steering system comprises a first device for steering said beam along a first direction and a second device for steering said beam along a second direction, orthogonal to said first direction.

20. An apparatus as claimed in claim 19, wherein said first and second devices are spaced apart and said beam is introduced into said beam steering system between said first and second devices and in a direction along a plane generally transverse to the direction in which the first and second devices are spaced apart.

21. An apparatus as claimed in claim 20, further comprising a reflector for reflecting said beam onto said first device.

22. An apparatus as claimed in claim 21, wherein said reflector comprises one of a prism and a planar mirror.

23. An apparatus as claimed in claim 20, wherein said first device comprises a planar mirror.

24. An apparatus as claimed in claim 23, further comprising mounting means for rotatably mounting said planar mirror.

25. An apparatus as claimed in claim 24, further comprising an actuator for driving rotation of said mirror to any predetermined position.

26. An apparatus as claimed in claim 24 or 25, further comprising a controller for controlling the rotational position of said first device.

27. An apparatus as claimed in claim 23, wherein said first device is in the form of a plate.

28. An apparatus as claimed in claim 27, wherein said receiving system comprises a reflector for receiving beam energy reflected from the target surface, and wherein said reflector is disposed on one side of said plate.

29. An apparatus as claimed in claim 28, wherein said detector is capable of detecting the position of the beam reflected from the reflector to provide a parameter for measuring the distance to a target object in the range or z-direction.

30. An apparatus as claimed in claim 18, further comprising a position detector for detecting the position of said received reflected beam, wherein the position is dependent on the angle between the incident and reflected beam energy at the target surface and thereby on the distance between said apparatus and the position from which said beam is reflected from said surface, and said apparatus further comprises a controller for controlling the beam size at said target surface based on the trajectory of said projected beam and/or the position of said beam at the target surface.

31. An apparatus as claimed in claim 1, wherein said receiving system further comprises a device for at least one of (i) forming an image of the received beam energy on said detector, (ii) focussing the beam energy on the detector, and (iii) controlling the size of the reflected beam at said detector.

32. An apparatus as claimed in claim 31, wherein said device comprises at least one lens.

33. An apparatus as claimed in claim 31, wherein the magnification factor M of the device or f/D has a value such that the size, ωᵢ, of the beam at the detector is less than two times the diffraction limited spot size of the device, or approximately equal to the diffraction limited spot size.

34. An apparatus as claimed in claim 31, further comprising means defining an aperture for reducing the aperture of the device.

35. An apparatus as claimed in claim 34, wherein the size of the aperture is such that the size ωᵢ of the beam at the detector is less than two times the diffraction limited spot size.

36. An apparatus as claimed in claim 1, wherein said detector comprises an array of beam sensitive detectors, each having a beam receiving area, and wherein said receiving system includes a device for making the beam size, ωᵢ, at the detector array greater than the area of a said beam sensitive detector, and preferably equal to or greater than the area of 2 or 3 beam sensitive detectors.

37. An apparatus as claimed in claim 1, wherein said beam of energy comprises a beam of (i) coherent radiation, or (ii) non-coherent radiation.

38. An apparatus as claimed in claim 1, further comprising a generator for generating said beam of energy.

39. An apparatus as claimed in claim 38, wherein said generator comprises a laser.

40. An apparatus as claimed in claim 38, further comprising an optical fiber at the output of said generator.

41. An apparatus as claimed in claim 1, further comprising a controller for controlling the power of said beam at said target surface.

42. An apparatus as claimed in claim 41, wherein said controller is adapted to control said power in response to a parameter indicative of the size of said beam at said target surface.

43. An apparatus comprising a projection system for projecting a beam of energy onto a target object, a receiving system for receiving reflected beam energy from the target object, a detector for detecting the received energy;
wherein said projection system comprises a focusing device for focusing the projected beam and wherein the width of the beam exiting said focusing device is 5 millimeters or more, 10 millimeters or more, 15 millimeters or more, 20 millimeters or more or 25 millimeters or more.

44. An apparatus comprising a projection system for projecting a beam of energy onto a target object, a receiving system for receiving reflected beam energy from the target object, a detector for detecting the received energy;
wherein said projection system comprises a focusing device for focusing said projected beam to a beam width of 500 microns or less, 400 microns or less, 300 microns or less, 200 microns or less, 100 microns or less, 75 microns, 50 microns or less, or 25 microns or less.

45. An apparatus comprising a projection system for projecting a beam of energy onto a target object, a receiving system for receiving reflected beam energy from the target object, a detector for detecting the received energy, wherein said projection system comprises a focusing device for focusing the projected beam, a beam steering system comprising a first device for moving said beam along a first direction and a second device for moving said beam along a second direction orthogonal to said first direction, said first and second devices being spaced apart and a reflector between said first and second devices for reflecting a beam introduced along a plane transverse to the direction in which said first and second devices are spaced apart and between said first and second devices, towards said first device.

46. An apparatus as claimed in claim 45, wherein said reflector comprises a prism.

47. An apparatus comprising a projection system for projecting a beam of energy onto a target object, a receiving system for receiving reflected beam energy from the target object, a detector for detecting the received energy;
wherein said projection system comprises a variable focusing device for varying the focal length of the projected beam and for focusing the beam onto the target object.

48. An apparatus as claimed in claim 47, further comprising a measuring system for measuring a parameter indicative of whether said beam is focused at said target object.

49. An apparatus as claimed in claim 48, wherein said parameter is related to the distance between said focusing device and said object.

50. An apparatus as claimed in claim 48, further comprising a controller for varying the focal length of the beam in response to the measured parameter.

51. An apparatus as claimed in claim 47, wherein said projection system comprises a scanner for scanning the projected beam in at least one direction.

52. An apparatus as claimed in claim 47, wherein said projection system comprises a scanner for scanning the projected beam in a first direction and for scanning the projected beam in a second direction orthogonal to said first direction.

53. An apparatus as claimed in claim 47, further comprising a scanner for scanning the received beam energy onto the detector.

54. An apparatus as claimed in claim 53, wherein said scanner is adapted for scanning the received beam energy in a first direction and a second direction orthogonal to said first direction.

55. An apparatus as claimed in claim 51, further comprising a scanner for scanning the received beam energy onto the detector as the projected beam scans said target object.

56. An apparatus as claimed in claim 47, wherein said detector is adapted for detecting changes in the position of the reflected beam energy due to changes in the position along the range direction on the object from which said beam is reflected.

57. An apparatus as claimed in claim 56, wherein the position of the reflected beam energy at the detector depends on the angle between the projected beam and the reflected beam energy at the target surface.

58. An apparatus as claimed in claim 56, further comprising determining means for determining a value of said position along said range direction based on the position of the received energy on said detector.

59. An apparatus as claimed in claim 58, further comprising a controller for controlling the variable focussing device to control the beam size at the target surface based on the position of the reflected beam energy on the detector and/or the range of the position on the target surface from which said beam is reflected as determined by said determining means.

60. An apparatus as claimed in claim 56, further comprising a steering system for steering said projected beam, and determining means for determining the three dimensional position at which said projected beam intercepts the target surface, based on the beam direction and the detected position of the received beam energy at the detector.

61. An apparatus as claimed in claim 60, further comprising a controller for controlling said variable focusing device to control the beam size at the target surface at each of a plurality of different positions on the target surface.

62. An apparatus as claimed in claim 61, wherein said controller is adapted to control said beam size in accordance with a predetermined beam size criterion.

63. An apparatus as claimed in claim 62, wherein said criterion comprises maintaining said beam size within a predetermined range or at a predetermined value for different positions on said target surface.

64. An apparatus as claimed in claim 60, further comprising a comparison means for comparing data derived from one or more three dimensional position measurements of the target object with data defining a model of the object.

65. An apparatus as claimed in claim 47, wherein said receiving system further comprises a focusing device for focusing the received beam energy onto said detector.

66. An apparatus as claimed in claim 47, wherein said projection system comprises a scanner for scanning said projected beam, and wherein said scanner comprises a movable reflector.

67. An apparatus as claimed in claim 66, further comprising mounting means for rotatably mounting said reflector for rotation about an axis.

68. An apparatus as claimed in claim 67, wherein said axis is proximate the reflective surface of said reflector.

69. An apparatus as claimed in claim 67, wherein said reflector has a width and a thickness and the width of said reflector is greater than its thickness.

70. An apparatus as claimed in claim 69, wherein said reflector is in the form of a plate.

71. An apparatus as claimed in claim 66, further comprising a scanner for scanning said received beam in a first direction and wherein said scanner comprises a reflector operably connected to the scanner for scanning said projected beam in said first direction.

72. An apparatus as claimed in claim 66, further comprising a driver for driving movement of said scanner and a controller for periodically changing the direction of movement of said deflector.

73. An apparatus as claimed in claim 72, wherein said controller is capable of changing the range of the scan.

74. An apparatus as claimed in claim 72, wherein said controller is adapted to control the position of at least one end of the range of the scan.

75. An apparatus as claimed in of claim 66, further comprising a second scanner for scanning said beam in a second direction orthogonal to said first direction and a reflector between said first and second scanners for reflecting said beam onto said first scanner.

76. An apparatus as claimed in claim 75, wherein said reflector comprises a prism.

77. An apparatus as claimed in claim 47, wherein said projection system further comprises a beam expander for expanding the size of said beam.

78. An apparatus as claimed in claim 77, wherein said beam expander is positioned before said focusing device.

79. An apparatus as claimed in claim 47, further comprising a collimator for collimating said projected beam before said focussing device.

80. An apparatus as claimed in claim 79, further comprising a laser source for generating said beam of energy and for feeding said energy into said collimator.

81. An apparatus as claimed in claim 77 to, wherein said beam expander is capable of outputting a beam having a diameter of at least 5 millimeters or more.

82. An apparatus as claimed in claim 81, wherein said beam expander is capable of outputting a beam having a diameter in the range of between 5 to 40 millimeters or more.

83. An apparatus as claimed in claim 47, wherein the beam output from said focusing device has a width of 5 to 40 millimeters or more.

84. An apparatus as claimed in claim 47, wherein said focusing device is capable of focusing said beam at said object to a beam width of between 500 and 10 microns or less.

85. An apparatus as claimed in claim 84, wherein said focusing device is capable of focusing said beam at said object to a width of between 1 and 200 microns.

86. A method of obtaining information about a target object comprising the steps of:
projecting a beam of energy onto a target object, measuring a parameter for use in focusing the beam onto the object,
controlling the focal length of the beam based on said parameter to control the beam size at the target object, receiving beam energy reflected from said object,
detecting the position of the reflected beam energy, and
based on said detected position, determining the position of the beam on said target along a z-direction extending between said object and a reference position spaced from said object.

87. A method as claimed in claim 86, further comprising determining the position of the beam on said object in at least one other direction orthogonal to said z-direction.

88. A method as claimed in claim 86, further comprising focusing the received beam energy onto a detector.

89. A method as claimed in claim 86, wherein said parameter is indicative of the focal length of the beam required to focus the beam onto the object.

90. A method as claimed in claim 89, wherein the step of measuring said parameter comprises receiving beam energy reflected from said object, detecting the position of the reflected beam energy and measuring said parameter on the basis of the detected position of said reflected beam energy, wherein said position of the received reflected beam energy depends on the angle between the projected beam and direction of the received reflected beam energy at the target surface.

91. A method as claimed in claim 86, further comprising directing said beam to each of a plurality of selected different positions on said object, and for each position, detecting the position of the reflected beam energy, and determining the position of the beam on said object along said z-direction based on said detected position.

92. A method as claimed in claim 91, further comprising the steps of selecting a discreet area on said object that is smaller than the total area of said object that can be viewed in one direction and restricting said plurality of selected different positions on said object to said discreet area.

93. A method as claimed in claim 92, further comprising identifying the position of a feature of said object in at least one direction orthogonal to said z-direction based on said determined positions.

94. A method as claimed in claim 92, further comprising directing said beam to a position on said object outside said discreet area, detecting the position of the reflected beam energy and determining the position of the beam on said object along said z-direction based on said detected position.

95. A method as claimed in claim 92, further comprising selecting another discreet area on said object that is smaller than the total area of said object that can be viewed from one direction, directing said beam to each of a plurality of selected different positions on said object within said other area, and for each position, detecting the position of the reflected beam, and determining the position of the beam on said object along said direction based on said detected position.

96. A method as claimed in claim 95, further comprising identifying the position of a feature of said object based on said determined positions.

97. A method as claimed in claim 96, further comprising determining a parameter indicative of the physical relationship between said identified features.

98. A method as claimed in claim 97, further comprising comparing said parameter with a predetermined parameter.

99. A method as claimed in claim 97, wherein said parameter comprises at least one of a distance and an angle between said features.

100. A method as claimed in claim 92, further comprising selecting said discreet area based on an image of said object.

101. A method as claimed in claim 100, wherein said image comprises a photographic image.

102. A method as claimed in claim 86, further comprising the steps of selecting a discreet area on said object that is smaller than the total area of said object that can be viewed from one direction, making a plurality of measurements at different positions on said object within said area, each measurement comprising the steps of detecting the position of the reflected beam energy from said object and determining the position of the beam on said object along said z-direction based on said detected position.

103. A method as claimed in claim 102, further comprising determining the position of the beam on said object in at least one of said other orthogonal directions.

104. A method as claimed in claim 86, comprising moving said projected beam to a plurality of different locations on said target object, and for each location, measuring the three dimensional position of the projected beam at the target surface by measuring the direction of the projected beam and the range of the position of the projected beam at the target surface from the position of the received reflected beam energy, and controlling the beam size at the target surface at each location.

105. A method as claimed in claim 104, comprising controlling the beam size according to a predetermined criteria.

106. A method as claimed in claim 104, comprising controlling the focal length of the beam to maintain the beam size in accordance with said criteria for each different location.

107. A method as claimed in claim 106, comprising controlling the focal length based on the position of the detected reflected beam energy.

108. A method as claimed in claim 104, further comprising comparing data derived from said position measurements with data derived from a model of said object.

109. A method of obtaining information about a target surface comprising generating from said surface first data containing information about said target surface,
identifying a feature from said first data, and
generating from said target surface second data containing information about said feature, wherein the second data contains different information about said feature than said first data.

110. A method as claimed in claim 109, wherein obtaining information comprises performing a method as claimed in claim 86.

111. An apparatus as claimed in claim 1, further comprising identifying means for identifying said object.

112. An apparatus as claimed in claim 111, further comprising recording means coupled to the identifying means for recording an identity of said object.

113. An apparatus as claimed in claim 111, wherein said identifying means comprises any one or more of a part number reader, a bar code reader and a means for identifying a feature of said object.
